(19) United States
(12) Patent Application Publication
(10) Pub. No.: US 2005/0244184 A1
(43) Pub. Date: Nov. 3, 2005

(54) Oxidation catalyst device, controlling method thereof and wet electrophotographic image forming apparatus having the same

(75) Inventors: Sung-Dae Kim, Suwon-si (KR); Myoung-Chan Kim, Seoul (KR); Woong-Jae Chang, Seoul (KR); Jeong-Seop Hong, Mungyeong-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/035,008

(22) Filed: Jan. 14, 2005

(30) Foreign Application Priority Data
Apr. 30, 2004 (KR) 2004-30733

(51) Int. Cl. G03G 15/00

(52) U.S. Cl. 399/93

(57) ABSTRACT

Disclosed is an oxidation catalyst device comprising a duct, a fan, a liquefier member, heaters, and an oxidation catalyst filter. Here, the liquefier member liquefies part of the carrier vapor produced by a fixing device, so that a catalyst of the oxidation catalyst filter shares part of the oxidation of the carrier vapor. The control method of the oxidation catalyst device comprises the steps of intaking the carrier vapor produced inside of a fixing device; cooling and liquefying the carrier vapor taken in; performing a first oxidation on the remaining unliquefied carrier vapor; and performing a second oxidation on the liquefied carrier among the carrier vapor.

### CROSS-REFERENCE TO RELATED APPLICATIONS

This application claims the benefit under 35 U.S.C. §119(a) of Korean Patent Application No. 2004-30733, filed on Apr. 30, 2004, the entire content of which is hereby incorporated by reference.

### BACKGROUND OF THE INVENTION

1. Field of the Invention:

The present invention relates in general to an electrophotographic image forming apparatus., More particularly, The present invention relates to an oxidation catalyst device for improving oxidation efficiency of the vapor of a carrier produced as a developer-coated paper passes through a fixing device, a method for controlling an oxidation catalyst and a wet electrophotographic image forming apparatus having the same.

2. Description of the Related Art

In general, a wet electrophotographic image forming apparatus is a printing apparatus for printing a desired image by scanning a laser beam onto a photosensitive medium to form an electrostatic latent image, developing the electrostatic latent image to a visible image with use of a developer, and transferring the visible image onto a sheet or recording medium. The wet electrophotographic image forming apparatus creates clearer images as compared to a dry electrophotographic image forming apparatus using dry toner. Thus, for color printing, the wet electrophotographic image forming apparatus is preferred.

FIG. 1 is a schematic diagram illustrating the structure of a conventional wet electrophotographic image forming apparatus.

As shown in FIG. 1, the wet electrophotographic image forming apparatus includes a main body 110, a plurality of photosensitive drums 121, 122, 123, and 124 for bearing an electrostatic latent image, a plurality of charging devices 131, 132, 133, and 134 for respectively charging the surfaces of the photosensitive drums 121, 122, 123, and 124 to a predetermined electric potential, a plurality of exposing devices 141, 142, 143, and 144 for irradiating a laser beam to the surfaces of the photosensitive drums 121, 122, 123, and 123, respectively, a plurality of developing devices 151, 152, 153, and 154 for supplying a developer to each of the photosensitive drums 121, 122, 123, and 124 and thereby, forming visible images, a plurality of first transfer rollers 171, 172, 173, and 174 for transferring the visible images formed on the photosensitive drums 121, 122, 123, and 124 to a transfer belt 160, a second transfer roller 180 for transferring to a paper P an image that is superposed with the visible images and is finally formed on the transfer belt 160, and a fixing device 190 for applying heat and pressure to the paper where the final image is transferred to fix the final image onto the paper P.

The developing devices 151, 152, 153, and 154 respectively have developers in different colors, and supply the color developer to each of the photosensitive drums 121, 122, 123, and 124. The developer consists of a toner ink and a carrier liquid like Norpar. Norpar is the brand name for a line of hydrocarbon fluids, such as, C₁₀H₂₂, C₁₁H₂₄, C₁₂H₂₆, C₁₃H₂₈. Visible images with a developer on the photosensitive drums 121, 122, 123, and 124 are transferred onto the transfer belt 160 and are superposed with each other to form a final image. Thusly formed final image is then printed on the paper P. Meanwhile, the application of strong heat evaporates the carrier liquid to an hydrocarbon gas, such as, CH₄, which is eventually discharged outside.

The hydrocarbon gases are classified as volatile organic compounds (VOC), and if discharged outside with no chemical treatment thereon, they generate offensive odors. For these problems, diverse techniques have been developed to remove the inflammable hydrocarbon gases.

Some of the well-known techniques that are currently used include a filtering technique for physically removing the gases with use of a carbon filter, such as, an activated carbon, a direct-combustion technique for burning the gases at their burning points (600-800° C.), and a catalytic oxidation technique for burning the gases with use of a catalyst at a relatively low temperature range (150-400° C.) and oxidizing the gases to water and carbon dioxide.

Unfortunately however, the filtering technique is not convenient to use because every time an amount of the carrier greater than a fixed amount is collected inside the filter, the filter must be replaced. This is mainly because the carbon filter is incapable of resolving the carrier collected therein. As for the direct-combustion technique, the problem of safety due to the generation of a high heat has discouraged people from using the technique. Because of these problems, the catalytic oxidation technique that removes the carrier vapor of the wet electrophotographic image forming apparatus has been mainly used, and there is great interest in developing a technique for improving the oxidation efficiency of the carrier vapor.

Accordingly, there is a need for an oxidation catalyst device and an oxidation control method for improving the oxidation efficiency of the carrier vapor produced by an image forming apparatus.

### SUMMARY OF THE INVENTION

It is, therefore, an object of the present invention to provide an oxidation catalyst device and a control method for improving oxidation efficiency of the carrier vapor produced as a developer-coated sheet passes through a fixing device.

To overcome the above problems and to provide other advantages, there is provided an oxidation catalyst device for use in wet electrophotographic image forming apparatus, the device comprising a duct for guiding the vapor of a carrier produced from a fixing device that applies heat and pressure to a developer-adhered paper to the outside of the fixing device; a fan for blowing the carrier vapor to the outside of the duct; a liquefier member for liquefying the carrier vapor exhausted by the fan; a first heater for heating the carrier vapor that passed through the liquefier member; and an oxidation catalyst filter for catalyzing the oxidation of the carrier vapor heated by the first heater.

Preferably, the device further comprises a second heater for heating a carrier liquid that is liquefied while passing through the liquefier member.

Preferably, the device further comprises a carrier liquid storage for storing the carrier liquid that is passed through the liquefier member.

Preferably, the liquefier member is a metallic duct.

Preferably, the device further comprises thermally conductive members installed in such a manner as to pass through the liquefier member to the outside. And, each of the thermally conductive member is installed in such a manner that one end thereof inserted into the liquefier member is inclined downward. More preferably, the thermally conductive members are metallic pins.

Preferably, there is an insulating member disposed between the liquefier member and the oxidation catalyst filter.

Preferably, the oxidation catalyst filter is installed in an upper portion of the first heater, so that a path that the carrier vapor takes to go through the first heater to the oxidation catalyst filter has an upward structure.

According to another aspect of the present invention, a wet electrophotographic image forming apparatus comprises a photosensitive medium; an exposing device for scanning a laser beam onto the photosensitive medium; a developing device for adhering a developer comprising an ink and a carrier to the photosensitive medium; a transfer device for transferring the developer adhered to the photosensitive medium onto a paper; a fixing device for applying heat to fix the developer onto the paper; and an oxidation catalyst device for oxidizing a carrier produced by the fixing device, wherein the oxidation catalyst device includes a duct, a fan, a liquefier member heaters, and an oxidation catalyst filter.

Another aspect of the present invention provides a control method of an oxidation catalyst device in a wet electrophotographic image forming apparatus, the method including the steps of: sucking in the vapor of a carrier produced inside of a fixing device that applies heat and pressure to a paper coated with a developer; cooling and liquefying the carrier vapor sucked in; performing a first oxidation on the remaining unliquefied carrier vapor; and performing a second oxidation on the liquefied carrier among the carrier vapor.

Preferably, the first oxidation step includes the sub-steps of: heating the remaining unliquefied carrier vapor; and oxidizing the heated carrier vapor in the presence of a catalyst.

Preferably, the second oxidation step includes the sub-steps of: a first heating step for heating and evaporating the liquefied carrier to carrier vapor; a second heating step for heating the carrier vapor; and catalytically oxidizing the heated carrier vapor in the second heating step.

### BRIEF DESCRIPTION OF THE DRAWINGS

The above aspects and features of the present invention will be more apparent by describing certain embodiments of the present invention with reference to the accompanying drawings, in which:

FIG. 1 is a schematic diagram illustrating the structure of a conventional wet electrophotographic image forming apparatus;

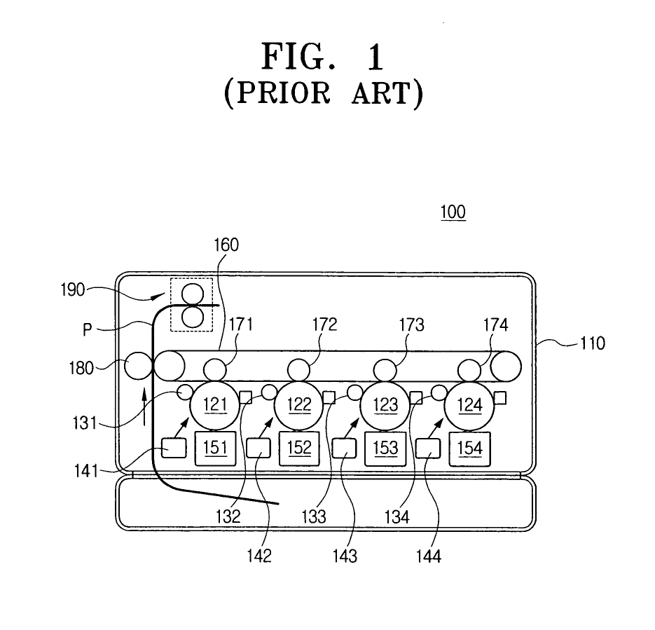

FIG. 2 is a schematic diagram illustrating the structure of a wet electrophotographic image forming apparatus according to an embodiment of the present invention;

FIG. 3 is a schematic diagram of a fixing device of FIG. 2;

FIG. 4 is a longitudinal sectional view of an oxidation catalyst device of FIG. 2;

FIG. 5 is a longitudinal sectional view of an oxidation catalyst device according to an embodiment of the present invention;

FIG. 6 is a longitudinal sectional view of an oxidation catalyst device according to an embodiment of the present invention; and

FIG. 7 is a flow chart describing a controlling method of an oxidation catalyst device according to an embodiment of the present invention.

It should be understood that like reference numbers are used to refer to like elements, features and structures throughout the drawings.

### DETAILED DESCRIPTION OF THE EXEMPLARY EMBODIMENTS

A preferred embodiment of the present invention will be described herein below with reference to the accompanying drawings.

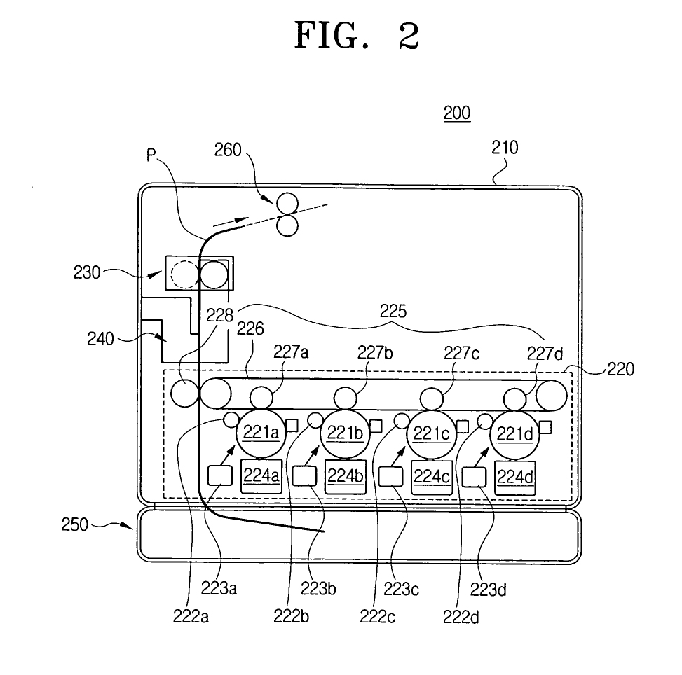

FIG. 2 is a schematic diagram illustrating the structure of a wet electrophotographic image forming apparatus according to an embodiment of the present invention.

As shown in FIG. 2, the wet electrophotographic image forming apparatus 200 comprises a main body 210 forming an exterior of the image forming apparatus; a print engine 220 for forming a visible image with use of a developer, and transferring the visible image to a paper P; an image fixing device 230 for fixing the visible image transferred onto the paper P; an oxidation catalyst device 240 is connected to the fixing device 230 to allow airflow from the inside of the fixing device 230 to the outside of the main body 210 of the image forming apparatus; a paper feeding device 250 for feeding a paper P to the print engine 220; and a paper releasing device 260 for releasing the printed paper P.

The print engine 220 comprises photosensitive drums 221a, 221b, 221c, and 221d as a photosensitive medium for forming an electrostatic latent image, charging devices 222a, 222b, 222c, and 222d, exposing devices 223a, 223b, 223c, and 222d, and developing devices 224a, 224b, 224c, and 224d, and a transfer device 225.

The charging devices 222a, 222b, 222c, and 222d, respectively, charge the surfaces of the photosensitive drums 221a, 221b, 221c, and 221d to a predetermined potential, which enables an electrostatic latent image to form on the surface of each photosensitive drum 221a, 221b, 221c, and 221d.

The exposing devices 223a, 223b, 223c, and 223d generate laser beams, and scans them onto the surfaces of the photosensitive drums 221a, 221b, 221c, and 221d, each of which is charged to the predetermined potential by the charging devices 222a, 222b, 222c, and 222d. Upon receiving the laser beams, the surfaces of the photosensitive drums 221a, 221b, 221c, and 221d bear the electrostatic latent images due to the change in potential.

The developing devices 224a, 224b, 224c, and 224d supply a developer to each of the photosensitive drums 221a, 221b, 221c, and 221d. Each of the developing devices 224a, 224b, 224c, and 224d stores a different color of the developer, such as, yellow, magenta, cyan, and black, and coats the electrostatic latent image formed on the surface of each photosensitive drum 221a, 221b, 221c, and 221d with its developer. The developer makes the electrostatic image formed on the surface of each photosensitive drum 221a, 221b, 221c, and 221d visible. The developer consists of a toner ink and a carrier liquid, like Norpar. Norpar is the brand name for a line of hydrocarbon fluids, such as, C₁₀H₂₂, C₁₁H₂₄, C₁₂H₂₆, C₁₃H₂₈. When Norpar evaporates, hydrocarbon gases, such as, CH₄, are produced.

The transfer device 225 comprises a transfer belt 226 that moves on a track in contact with the photosensitive drums 221a, 221b, 221c, and 221d; first transfer rollers 227a, 227b, 227c, and 227d for transferring the visible image formed on each photosensitive drum 221a, 221b, 221c, and 221d to the transfer belt 226; and a second transfer roller 228 for transferring onto a paper P a final image, which is obtained from the overlapped visible images on the transfer belt 226.

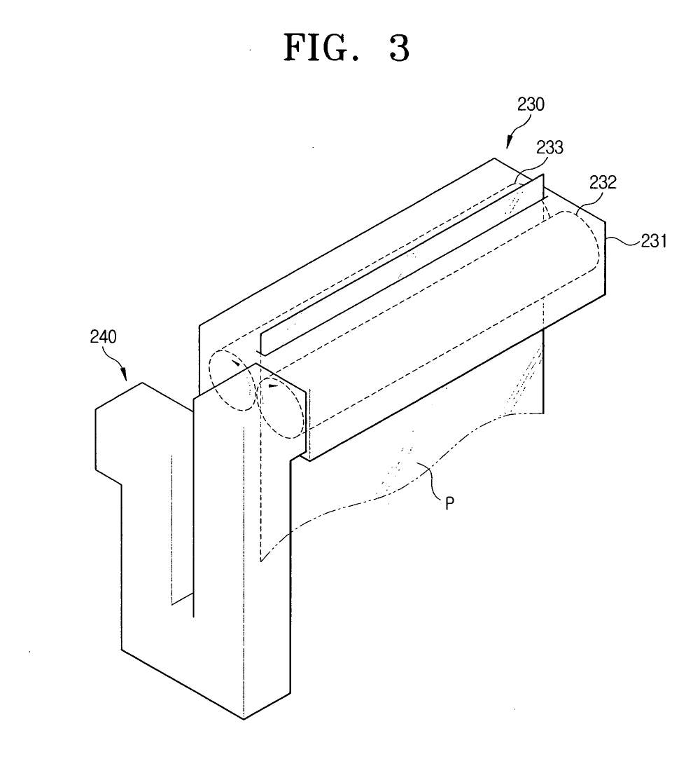

The fixing device 230 applies heat and pressure to the paper P where a color image is transferred in order to evaporate the carrier in the developer, and fixes the image on the paper P. As shown in FIG. 3, the fixing device 230 includes a case 231, a heating roller 232 installed inside the case 231 for generating high heat, and a pressing roller 233 installed inside the case 231 to be in contact with the heating roller 232, thereby rotating together. The heating roller 232 is equipped with a heating element, such as a heating lamp or an electrothermal wire, to generate the high heat. Therefore, when the transferred image goes through the fixing device 230, a carrier liquid, like Norpar, is evaporated instantaneously by the high heat. This evaporated carrier contains any vapor from the evaporated moisture in originally in the paper, and the Norpar gas.

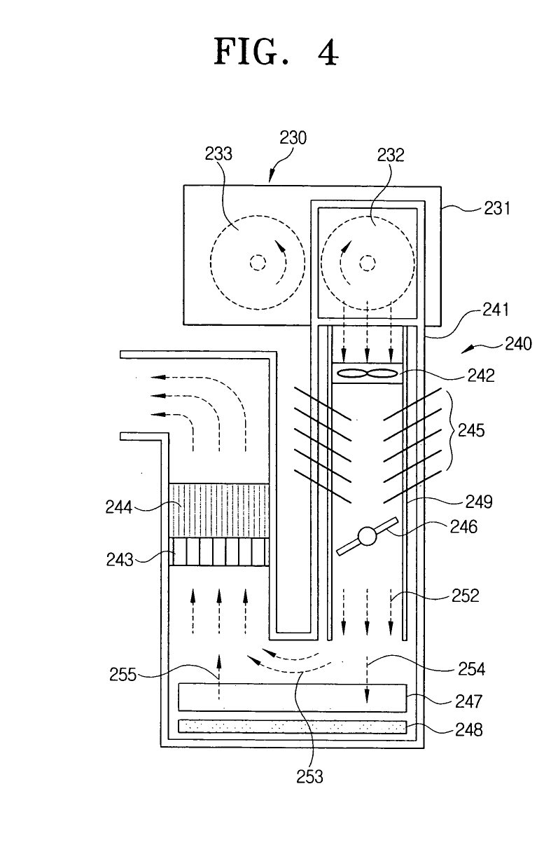

The oxidation catalyst device 240 catalyzes the oxidation the carrier vapor produced at the fixing device 230 by the evaporation of the developer on the paper P. As shown in FIG. 4, the oxidation catalyst device 240 comprises a duct 241, a fan 242, a liquefier member 249, a carrier liquid storage member 247, a first heater 243, a second heater 248, and an oxidation catalyst filter 244.

The duct 241 has one end connected to the case 231 of the fixing device 230 to guide the carrier vapor produced inside the case 231 to the exterior of the main body 210 (refer to FIG. 2).

The fan 242 is installed inside the duct 241, and blows the vapor of the carrier in the fixing device 230 to the oxidation catalyst device 240, which will be explained later in more detail.

The liquefier member 249 is installed inside the duct 241 in the form of a duct, and liquefies (for example, lowering the temperature) the carrier vapor absorbed by the fan 242. The vapor of the carrier that goes through the fixing device 230 becomes supersaturated at a high temperature. A substantial amount of carrier vapor is liquefied as it goes through the liquefier member 249. Therefore, to liquefy a greater amount of the carrier vapor, the liquefier member 249 preferably maintains the same temperature as the room temperature (about 25° C.-35° C.). Although the liquefier member 249 can be made from diverse materials, metallic materials with an excellent thermal conductivity to the outside air are preferred. As described above, since the liquefier member 249 should maintain the same room temperature as the room temperature, it is very important to make sure the liquefier member 249 is insulated from the high-temperature oxidation catalyst filter 244 that will be explained later in more detail.

In this exemplary embodiment, the liquefier member 249 is installed inside the duct 241, but it can also be connected directly to the fixing device 230 without the duct. In such a case, the insulation between the liquefier member 249 and the oxidation catalyst filter 244 becomes much more important.

To improve the liquefaction rate of the liquefier member 249, a plurality of thermally conductive members 245 are employed. Particularly, the thermally conductive members 245 are installed along the path of the carrier vapor as it passes the liquefier member 249, to increase the amount of carrier liquid. That is, the high-temperature vapor of the carrier absorbed from the fixing device 230 collides with the thermally conductive members 245 and thus, lingers longer in the liquefier member 249, consequently increasing the amount of carrier liquid. Therefore, the thermally conductive members 245 are installed in such a manner that they pass through the liquefier member 249 to be exposed to outside. In this way, the thermally conductive members 245 are able to conduct the outside temperature and maintain the inside of the liquefier member 249 at the room temperature. The thermally conductive members 245 are preferably metallic pin members for increased heat conductivity, although they are not limited to being only metallic. In addition, as shown in the FIG. 4, one end of each thermally conductive member 245, which is inserted into the liquefier member 249, is preferably inclined downward.

Although much of the carrier 252 is liquefied by the liquefier member 249, part of the carrier 252 still exists as a gas. The carrier gas 253 moves to the oxidation catalyst filter 244, while the carrier liquid 254 is stored in the carrier liquid storage member 247. The second heater 248 for heating and evaporating the carrier liquid 254 is provided at the bottom of the carrier liquid storage member 247. While a reprint operation is performed after the operation of the fixing device 230, the carrier liquid 254 is heated to evaporate. Thus, all of the carrier liquid having passed through the liquefier member 249 is converted into vapor 255 by the second heater 248, and is transferred to the oxidation catalyst filter 244.

In the meantime, the first heater 243 heats the remaining unliquefied carrier vapor 253 after having passed through the liquefier member 249, and the re-evaporated carrier 255 from the carrier liquid through the operation of the second heater 248 to about 200° C.

The oxidation catalyst filter 244 is coated with an oxidation catalyst, platinum (Pt) or palladium (Pd) for example, and catalyzes the of the carrier vapor at 200° C., that is, converting the activated hydrocarbon gas into water and carbon dioxide. The oxidation catalyst filter 244 first oxidizes the remaining carrier vapor 253 that has not been liquefied by the liquefier member 249, and then oxidizes the re-evaporated carrier vapor 255, which is carrier liquid evaporated the second heater 248. The number of first heaters 243 and the oxidation catalyst filters 244 built in the duct 241 can be increased to 2 or 3 as desired. As shown in FIG. 4, the oxidation catalyst filter 244 is installed at the top of the first heater 243 and thus, allows the vapor of the carrier to make an upward movement from the first heater 243 to the oxidation catalyst filter 244. This structure ensures that there is no remaining carrier liquid to be in contact with the catalyst, which reduces the performance of the catalyst and the lifespan of the catalyst.

A valve 246 is disposed inside the liquefier member 249, and is closed when the power of the image forming apparatus is off, blocking the intake and exhaust of carrier vapor. Preferably, the valve 246 is a solenoid valve, and more explanations on this will be omitted for the sake of brevity.

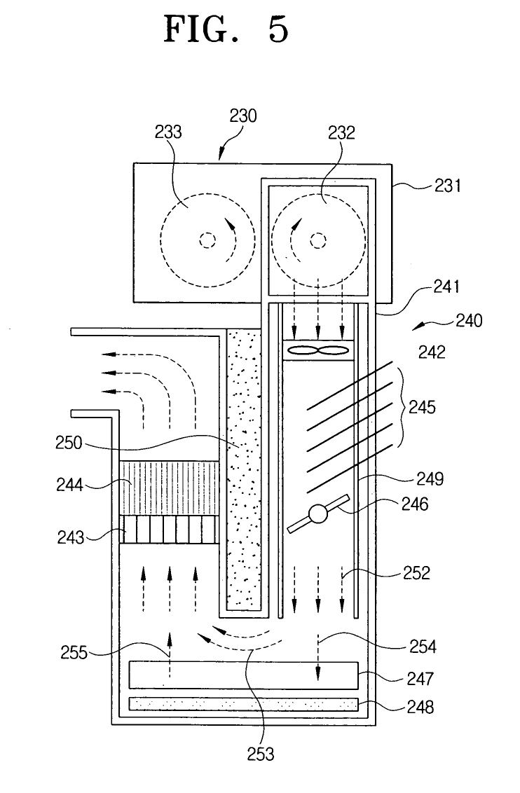

FIG. 5 illustrates an oxidation catalyst device 240 according to a second embodiment of the present invention. The second embodiment of the oxidation catalyst device differs from the first embodiment of the oxidation catalyst device in that there is an insulating member 250 between the liquefier member 249 and the oxidation catalyst filter 244. As mentioned before, it is important that the liquefier member 240 maintains its temperature at room temperature. But since the oxidation catalyst filter 244 has a very high temperature, the liquefier member 249 should be protected from the heat of the oxidation catalyst filter. The insulating member 250 is, therefore, used for insulating the liquefier member 249 from the oxidation catalyst filter 244. The use of the insulating member 250 makes it possible to install one of the thermally conductive member 245 on only one side of the liquefier member 249, as compared to the first embodiment where the thermally conductive members 245 are installed on both sides of the liquefier member 249. As, it turned out that there is no difference in the performance of the thermally conductive member 245.

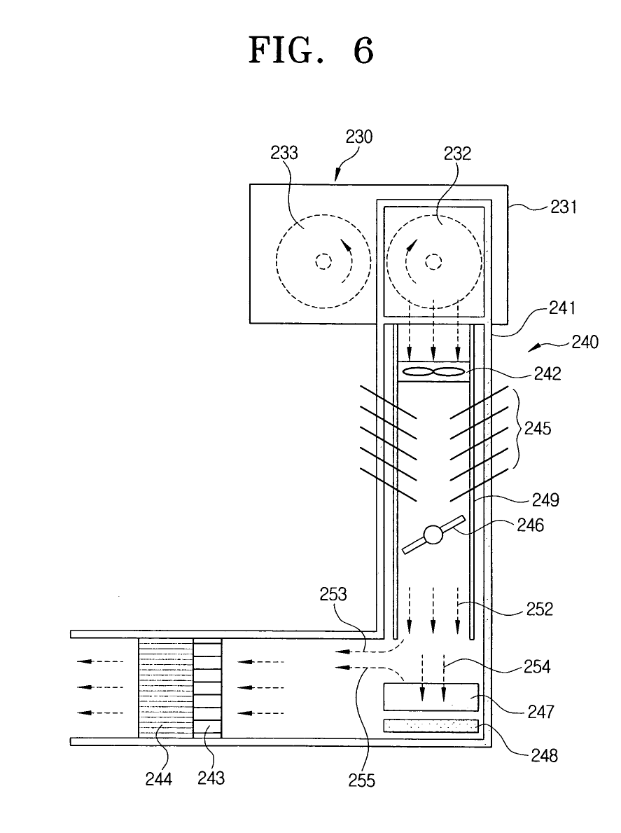

FIG. 6 illustrates an oxidation catalyst device 240 according to a third embodiment of the present invention. In the third embodiment, to ensure the liquefier member 249 is not affected by the high temperature of the oxidation catalyst filter 244, the liquefier member 249 and the oxidation catalyst filter 244 are arranged almost perpendicular to each other. It is discovered that the farther the liquefier member 249 is from the oxidation catalyst filter 244, the less affected the liquefier member 249 is by the temperature of the oxidation catalyst filter 244.

The same reference numerals used in the first embodiment are used again in the second and the third embodiment illustrated in FIG. 5 and FIG. 6. Since the same constituent elements have the same functions, no details thereon will be provided here.

The following description explains the control method of the oxidation catalyst device, and the operation of the wet electrophotographic image forming apparatus having the same.

When a print operation starts at the image forming apparatus 200, as shown in FIG. 2, laser beams from the exposing devices 223a, 223b, 223c, and 223d are irradiated on the surfaces of the photosensitive drums 221a, 221b, 221c, and 221d, respectively, which are charged by the charging devices 222a, 222b, 222c, and 222d to a predetermined potential. When the potential of the surface of each photosensitive drum 221a, 221b, 221c, and 221d changes, an electrostatic latent image is formed thereon. Then, the developing devices 224a, 224b, 224c, and 224d apply yellow, magenta, cyan and black colored developers onto the electrostatic latent images, respectively, to make the latent images visible. Thusly formed visible images in the four colors are transferred in sequence to the transfer belt 226 with help of the first transfer rollers 227a, 227b, 227c, and 227d. As a result, the four colors of the developers are superposed to form an image on the transfer belt 226. While the image forming process proceeds, the paper feeding device 250 feeds a paper P towards the transfer belt 226. When the paper P is located between the transfer belt 226 and the second transfer roller 228, the color image formed on the transfer belt 226 is then transferred onto the paper P with help of the second transfer roller 228, and the paper P keeps moving towards the fixing device 230.

As shown in FIG. 3, the paper P at the fixing device 230 passes through between the heating roller 232 and the pressing roller 233 and escapes from the fixing device 230, and is released to outside the main body 210 of the image forming apparatus through the paper releasing device 260. When the paper P passes between the heating roller 232 and the pressing roller 233, the carrier of the developer applied onto the paper P evaporates due to the heat generated from the heating roller 232, and the ink is fixed onto the paper P.

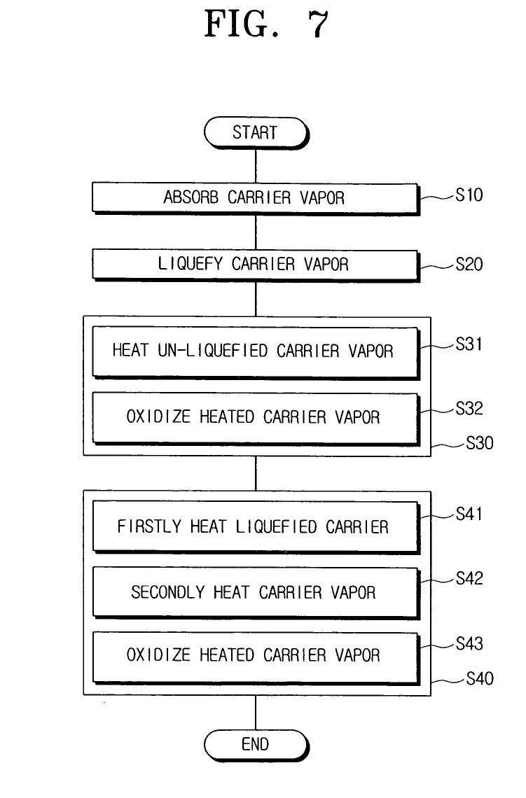

Referring to FIGS. 4 to 7, the carrier vapor produced inside the case 231 is blown by the fan 242 to the outside of the case 231, and is absorbed into the liquefier member 249 (S10, the absorbing step). A large quantity of the carrier vapor is liquefied as it goes through the liquefier member 249, and part of it exists as a gas (S20, the liquefying step). The carrier liquid 254 is stored in the carrier liquid storage member 247 either due to the precipitation of the carrier liquid 254 from the carrier vapor or it is blown into the carrier liquid storage 247 by the fan 242. Then, the remaining unliquefied carrier vapor 253 undergoes a first oxidation step (S30), while the carrier liquid 254 undergoes a second oxidation step (S40).

To detail the first oxidation step (S30), the remaining unliquefied carrier vapor 253 even after having passed through the liquefier member 249 goes through the first heater 243, and is heated up to approximately 200° C., the activation point (S31, the heating step), and then, flows to the oxidation catalyst filter 244. The carrier vapor passing through the oxidation catalyst filter 244 is oxidized to water and carbon dioxide, and is discharged outside of the duct 241 (S32, the oxidation step). Heat is produced during the oxidation of the carrier vapor at the oxidation catalyst filter 244 and thus, the temperature of the oxidation catalyst filter 244 is increased up to approximately 300° C.

Following the fixing and the printing operation, the second heater 248 heats the carrier liquid 254 until it evaporates (S41, the first heating step). During this procedure, the fan 242 keeps running to intake air. As described before, the re-evaporated carrier 255 through the operation of the second heater 248 undergoes another heating operation in the first heater 243 (S42, the second heating step), passes through the oxidation catalyst filter 244 to be oxidized to water and carbon dioxide, and discharged to the outside of the duct (S43, the oxidation step).

As described above, the remaining unliquefied carrier vapor 253 is primarily oxidized during the process of fixing an image onto the printed paper P by the fixing device, and the carrier liquid is re-evaporated and is secondarily oxidized. In this manner, the oxidation rate of the carrier vapor using a catalyst can be improved. Also, the carrier vapor absorbed from the fixing device is dividedly decomposed, so the amount of catalyst required can be reduced. This consequently reduces the total volume of the oxidation catalyst filter.

The entire carrier delivered from fixing device is completely evaporated and oxidized, leaving no carrier liquid behind. Therefore, the problems caused by the direct contact between the carrier liquid and the catalyst can be resolved.

Lastly, when the power of the image forming apparatus is off, the valve 246 inside the liquefier member 249 is automatically closed and thus, the carrier vapor can no longer enter in or exit the imaging device 200.

In conclusion, the oxidation catalyst device according to embodiments of the present invention oxidizes the carrier vapor absorbed from the fixing device with help of the liquefier member at two different times. Thus, the lifespan of the catalyst is extended, and the oxidation rate of the catalyst upon the vapor of the carrier is improved. Moreover, since the oxidation of the vapor of the carrier is divided into two parts, the total volume of the oxidation catalyst filter is reduced. Most of the carrier vapor delivered from the fixing device evaporates and is oxidized, and the path that the carrier vapor takes when going through the oxidation catalyst filter has an upward structure. Therefore, there is no carrier liquid left behind to make direct contact with the catalyst, which reduces the lifespan of the catalyst.

The foregoing embodiment and advantages are merely exemplary and are not to be construed as limiting the present invention. The present teaching can be readily applied to other types of apparatuses. Also, the description of the embodiments of the present invention is intended to be illustrative, and not to limit the scope of the claims, and many alternatives, modifications, and variations will be apparent to those skilled in the art.

1. An oxidation catalyst device for use in wet electrophotographic image forming apparatus, the device comprising:
a duct for guiding the carrier vapor produced from a fixing device that applies heat and pressure to a developer-adhered paper to the outside of the fixing device;
a fan for blowing the carrier vapor to the outside of the image forming device;
a liquefier member for liquefying the carrier vapor exhausted by the fan;
a first heater for heating the carrier vapor that passes through the liquefier member; and
an oxidation catalyst filter for catalyzing an oxidation of the carrier vapor heated by the first heater.

2. The device according to claim 1, further comprising:
a second heater for heating a carrier liquid that is liquefied while passing through the liquefier member.

3. The device according to claim 1, further comprising:
a carrier liquid storage for storing the carrier liquid that passes through the liquefier member.

4. The device according to claim 1, wherein the liquefier member is a metallic duct.

5. The device according to claim 1, further comprising:
thermally conductive members installed in such a manner to pass through the liquefier member to the outside of the duct.

6. The device according to claim 5, wherein each of the thermally conductive members is installed in such a manner that one end thereof inserted into the liquefier member is inclined downward.

7. The device according to claim 5, wherein the thermally conductive members are metallic pins.

8. The device according to claim 1, further comprising:
an insulating member disposed between the liquefier member and the oxidation catalyst filter.

9. The device according to claim 1, further comprising:
a valve installed in the liquefier member for blocking the intake and exhaust of the carrier vapor when the power of the image forming apparatus is off.

10. The device according to claim 9, wherein the valve is a solenoid valve.

11. The device according to claim 1, wherein the oxidation catalyst filter is installed in an upper portion of the first heater, so that a path that the carrier vapor takes to go through the first heater to the oxidation catalyst filter is upward.

12. A wet electrophotographic image forming apparatus, comprising:
a photosensitive medium;
a developing device for adhering a developer comprising an ink and a carrier to the photosensitive medium;
a transfer device for transferring the developer adhered to the photosensitive medium onto a paper;
a fixing device for applying heat to fix the developer onto the paper; and
an oxidation catalyst device for oxidizing a carrier vapor produced by the fixing device, wherein the oxidation catalyst device liquefies a part of the carrier vapor generated from the fixing device, and first oxidizes the remaining carrier vapor that has not been liquefied, and then oxidizes the liquefied carrier.

13. The wet electrophotographic image forming apparatus according to claim 12, wherein the oxidation catalyst device is comprised of:
a duct for guiding the carrier vapor produced from a fixing device that applies heat and pressure to a developer-adhered paper to outside of the fixing device;
a fan for blowing the carrier vapor outside of the duct;
a liquefier member for liquefying the carrier vapor exhausted by the fan;
a first heater for heating the vapor of the carrier that passed through the liquefier member;
a second heater for heating a carrier liquid that is liquefied while passing through the liquefier member; and
an oxidation catalyst filter for catalyzing an oxidation of the carrier vapor heated by the first heater.

14. The wet electrophotographic image forming apparatus according to claim 13, wherein the oxidation catalyst device further comprises a carrier liquid storage for storing the carrier liquid that is passed through the liquefier member.

15. The wet electrophotographic image forming apparatus according to claim 13, wherein the liquefier member is a metallic duct.

16. The wet electrophotographic image forming apparatus according to claim 13, wherein the oxidation catalyst device further comprises thermally conductive members installed in such a manner as to pass through the liquefier member to the outside of the duct.

17. The wet electrophotographic image forming apparatus according to claim 16, wherein each of the thermally conductive members is installed in such a manner that one end thereof is inserted into the liquefier member is inclined downward.

18. The wet electrophotographic image forming apparatus according to claim 16, wherein the thermally conductive members are metallic pins.

19. The wet electrophotographic image forming apparatus according to claim 13, wherein the oxidation catalyst device further comprises an insulating member disposed between the liquefier member and the oxidation catalyst filter.

20. The wet electrophotographic image forming apparatus according to claim 13, wherein the oxidation catalyst device further comprises a valve installed in the liquefier member, and for blocking the intake and exhaust of the carrier vapor when the power of the image forming apparatus is off.

21. The wet electrophotographic image forming apparatus according to claim 13, wherein the oxidation catalyst filter is installed in an upper portion of the first heater, so that a path that the carrier vapor takes to go through the first heater to the oxidation catalyst filter has an upward direction.

22. A control method of an oxidation catalyst device in a wet electrophotographic image forming apparatus, the method comprising the steps of:
taking in the carrier vapor produced inside of a fixing device that applies heat and pressure to a paper coated with a developer;
cooling and liquefying the carrier vapor taken in;
performing a first oxidation on the remaining unliquefied carrier vapor; and
performing a second oxidation of the liquefied carrier from among the carrier vapor.

23. The method according to claim 22, wherein the first oxidation step comprises the sub-steps of:
heating the remaining unliquefied carrier vapor; and
oxidizing the heated carrier vapor in the presence of a catalyst.

24. The method according to claim 22, wherein the second oxidation step comprises the sub-steps of:
a first heating step for heating and evaporating the liquefied carrier to carrier vapor;
a second heating step for heating the carrier vapor; and
catalytically oxidizing the heated carrier vapor in the second heating step.
